(19) United States
(12) Patent Application Publication
(10) Pub. No.: US 2024/0119371 A1
(43) Pub. Date: Apr. 11, 2024

(54) VEHICLE CONTROL SYSTEM AND METHOD

(71) Applicants: HYUNDAI MOTOR COMPANY, Seoul (KR); KIA CORPORATION, Seoul (KR)

(72) Inventor: Se Young Park, Suwon-si (KR)

(73) Assignees: HYUNDAI MOTOR COMPANY, Seoul (KR); KIA CORPORATION, Seoul (KR)

(21) Appl. No.: 18/109,013

(22) Filed: Feb. 13, 2023

(30) Foreign Application Priority Data
Oct. 7, 2022 (KR) 10-2022-0128256

(51) Int. Cl. G06Q 10/02; G06Q 50/30; G08G 1/123

(52) U.S. Cl. CPC G06Q 10/02; G06Q 50/30; G08G 1/123

(57) ABSTRACT

A vehicle control system and a method are disclosed. The vehicle control system includes a terminal that obtains boarding request information from a passenger, a vehicle that updates location information and remaining seat information, and a server. The server determines the terminal as a boarding schedule terminal when receiving the boarding request information from the terminal and determines whether the passenger is capable of boarding a vehicle based on a location of the boarding schedule terminal when it is determined that the vehicle approaches a stop corresponding to the boarding request information.

### CROSS-REFERENCE TO RELATED APPLICATION

This application claims the benefit of priority to Korean Patent Application No. 10-2022-0128256, filed in the Korean Intellectual Property Office on Oct. 7, 2022, the entire contents of which are incorporated herein by reference.

### TECHNICAL FIELD

The present disclosure relates to a vehicle control system and method.

### BACKGROUND

Recently, the results of developments in various industrial fields have been integrated with vehicles. As automobile-related technologies are developed, research and development of autonomous vehicles continue.

Thus, various services related to autonomous driving vehicles have been introduced, and in particular, when considering cost, environment, user convenience, and the like, it is expected that vehicle ownership will gradually shift to vehicle sharing.

Therefore, there is a need for technology for managing the boarding and alighting of passengers boarding or alighting a shared vehicle so as to extend the sharing service of an autonomous vehicle to various users based on the development of autonomous vehicle technology.

### SUMMARY

The present disclosure has been made to solve the above-mentioned problems occurring in the prior art while advantages achieved by the prior art are maintained intact.

An aspect of the present disclosure provides a vehicle control system and method capable of managing the boarding and alighting of passengers in a shared autonomous vehicle.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, a vehicle control system includes a terminal that obtains boarding request information from a passenger, a vehicle that updates location information and remaining seat information, and a server. The server determines the terminal as a boarding schedule terminal when receiving the boarding request information from the terminal and determines whether the passenger can board a vehicle based on a location of the boarding schedule terminal when it is determined that the vehicle approaches a stop corresponding to the boarding request information.

The server may receive the vehicle location information and the remaining seat information from the vehicle when the terminal is determined as the boarding schedule terminal.

The server may determine an expected arrival time of the vehicle based on the vehicle location information and may transmit the expected arrival time of the vehicle and the remaining seat information to the boarding schedule terminal when it is determined that the vehicle approaches the stop corresponding to the boarding request information.

The server may determine whether there is an available seat for the passenger based on the remaining seat information.

The server may receive a location of the boarding schedule terminal from the boarding schedule terminal when it is determined that there is an available seat for the passenger.

The server may transmit a message of guiding to use another vehicle to the boarding schedule terminal when it is determined that there is no available seat for the passenger.

The server may receive arrival information from the vehicle and transmit the arrival information to the boarding schedule terminal when it is determined that the passenger can board the vehicle.

The server may receive boarding information of the passenger from the vehicle, determine the boarding schedule terminal of the passenger who boards the vehicle as a boarding completion terminal, and transmit information on the boarding completion terminal to the vehicle when it is determined that the passenger boards the vehicle.

The server may receive non-boarding information of the passenger from the vehicle and may transmit a non-boarding guide message to the boarding schedule terminal of the passenger who does not board the vehicle when it is not determined that the passenger boards the vehicle.

The boarding completion terminal may obtain alighting request information.

The vehicle may determine the boarding completion terminal as an alighting request terminal and determine a state of the passenger according to a location of the alighting request terminal when it is determined that the alighting request information is received from the boarding completion terminal or the passenger inputs the alighting request information.

The vehicle may determine that the passenger is in an alighting schedule state when the alighting request terminal moves into a first area within a specified distance from a door.

The vehicle may transmit arrival expectation information to an alighting request stop corresponding to the alighting request information to the alighting request terminal when it is determined that the passenger is in the alighting schedule state.

The vehicle may determine that the passenger is in an alighting completion state when the alighting request terminal passes through the first area and moves to an outside of the vehicle after arrival at the alighting request stop.

The vehicle may transmit a non-alight guidance message to the alighting request terminal when it is determined that the alighting request terminal does not move to an outside of the vehicle after the arrival of the alighting request stop.

The vehicle may update the remaining seat information based on the passenger who is in the alighting schedule state and the passenger who is in the alighting completion state when it is determined that the passenger is in the alighting completion state.

The vehicle may transmit the updated remaining seat information to the server.

According to an aspect of the present disclosure, a vehicle control method includes obtaining boarding request information from a passenger, determining a terminal as a boarding schedule terminal when receiving the boarding request information from the terminal, and determining whether the passenger can board a vehicle based on a location of the boarding schedule terminal when it is determined that the vehicle approaches a stop corresponding to the boarding request information.

The vehicle control method may further include determining the boarding schedule terminal of the passenger who boards the vehicle as a boarding completion terminal when it is determined that the passenger boards the vehicle.

The vehicle control method may further include determining the boarding completion terminal as an alighting request terminal and determining a state of the passenger according to a location of the alighting request terminal when it is determined that alighting request information is received from the boarding completion terminal or the passenger inputs the alighting request information.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating the configuration of a vehicle control system according to an embodiment of the present disclosure;

FIG. 2 is a block diagram illustrating the configuration of a vehicle control apparatus according to an embodiment of the present disclosure;

FIG. 3 is a block diagram illustrating the configuration of a server according to an embodiment of the present disclosure;

FIG. 4 is a block diagram illustrating the configuration of a terminal according to an embodiment of the present disclosure;

FIGS. 5 and 6 are diagrams illustrating a vehicle control method according to an embodiment of the present disclosure; and

FIG. 7 is a block diagram illustrating a computing system according to an embodiment of the present disclosure.

### DETAILED DESCRIPTION

Hereinafter, some embodiments of the present disclosure are described in detail with reference to the drawings. In the drawings, it should be noted that identical or equivalent components are designated by identical reference numerals even when they are displayed on other drawings. Further, in describing an embodiment of the present disclosure, a detailed description of the related known configuration or function has been omitted where it has been determined that it would with the understanding of the described embodiment of the present disclosure.

In describing the components of an embodiment according to the present disclosure, terms such as “first,” “second,” “A,” “B,” “(a),” “(b),” and the like, may be used. These terms are merely intended to distinguish the components from other components. The terms do not limit the nature, order, or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

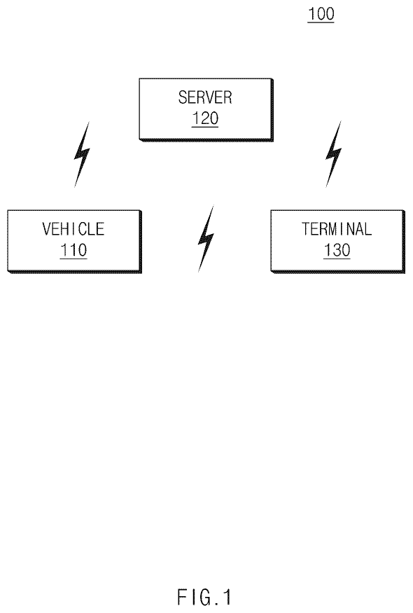

FIG. 1 is a block diagram illustrating the configuration of a vehicle control system according to an embodiment of the present disclosure.

As shown in FIG. 1, a vehicle control system 100 may include a vehicle 110, a server 120, and a terminal 130.

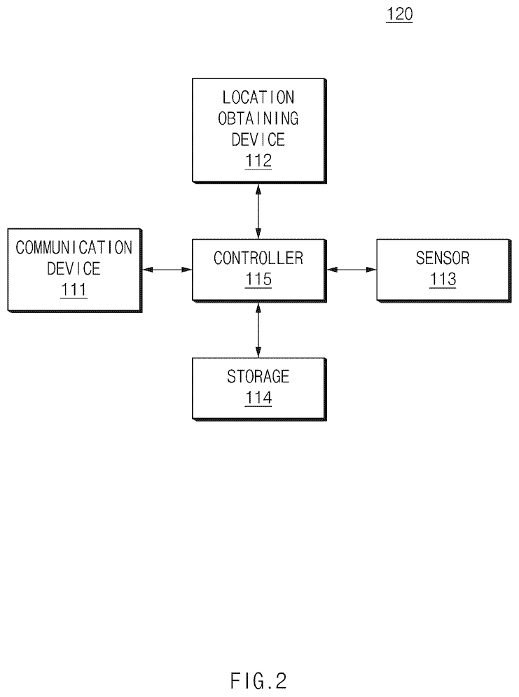

The vehicle 110 may update the location information of the vehicle in real-time and update the remaining seat information. For a more detailed description, refer to FIG. 2.

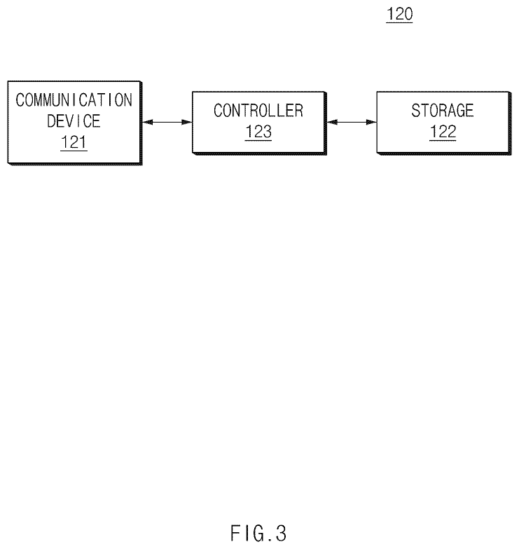

When boarding request information is received from a terminal, the server 120 may determine that the terminal is a boarding schedule terminal. When it is determined that the vehicle approaches a stop corresponding to the boarding request information received from the terminal, the server 120 may determine whether the passenger can board the vehicle based on the location of the boarding schedule terminal. For a more detailed description, refer to FIG. 3.

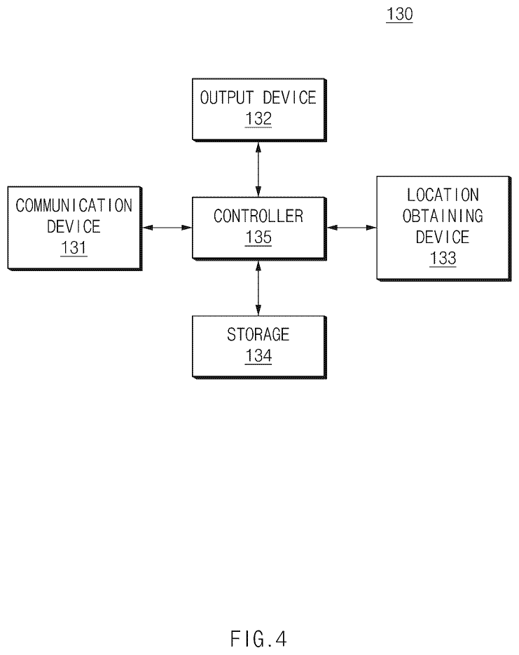

The terminal 130 may include a portable terminal that a passenger may carry, and according to an embodiment, may include a smartphone, an electronic pad, a laptop computer, or the like. The terminal 130 may obtain boarding request information or alighting request information from a passenger. For a more detailed description, refer to FIG. 4.

FIG. 2 is a block diagram illustrating the configuration of a vehicle control apparatus according to an embodiment of the present disclosure.

As shown in FIG. 2, the vehicle 110 may include a communication device 111, a location-obtaining device 112, a sensor 113, storage 114, and a controller 115.

The communication device 111 may communicate with the server 120 and the terminal 130 through various wireless communication schemes such as wireless fidelity (Wi-Fi), wireless broadband (WiBro), global system for mobile communication (GSM), code division multiple access (CDMA), wideband CDMA (WCDMA), universal mobile telecommunications system (UMTS), time division multiple access (TDMA), long-term evolution (LTE), ultra-wideband (UWB), and the like.

The location-obtaining device 112 may be provided with a global positioning system (GPS) receiving device to obtain vehicle location information in real-time. The location-obtaining device 112 may provide a map image of a certain area based on the location of a vehicle by map-matching the location of the vehicle to map data stored in advance.

The sensor 113 may sense various situations of the vehicle 110. The sensor 113 may include a speed sensor, a weight sensor, a seat sensor, and the like to detect the speed of the vehicle and the occupant's occupancy status.

The storage 114 may store at least one algorithm for performing calculation or execution of various commands for the operation of a vehicle according to an embodiment of the present disclosure. The storage 114 may include at least one storage medium of a flash memory, a hard disk, a memory card, a read-only memory (ROM), a random-access memory (RAM), a programmable ROM (PROM), an electrically erasable PROM (EEPROM), a magnetic memory, a magnetic disk, and an optical disk.

The controller 115 may be implemented with various processing devices such as a microprocessor and the like in which a semiconductor chip capable of performing operations or executions of various commands is built-in and may control operations of a vehicle according to an embodiment of the present disclosure. The controller 115 may be electrically connected to the communication device 111, the location-obtaining device 112, the sensor 113, and the storage 114 through a wired cable or various circuits to transmit an electrical signal including a control command and the like, and may transmit/receive an electrical signal including a control command and the like through various wireless communication networks such as a controller area network (CAN).

The controller 115 may receive the boarding request information received by the server 120 from the terminal 130. In addition, the controller 115 may receive the boarding schedule terminal information from the server 120.

The controller 115 may transmit real-time vehicle location information and remaining seat information to the server 120.

The controller 115 may transmit vehicle arrival information to the server 120 when the vehicle arrives at a boarding request stop. In addition, the controller 115 may request the location information of the boarding schedule terminal from the server 120 and receive the location information of the boarding schedule terminal from the server 120.

The controller 115 may determine whether a passenger who has the boarding schedule terminal has boarded the vehicle. According to an embodiment, the controller 115 may determine that a passenger has boarded the vehicle when the boarding schedule terminal is in the vehicle based on the location of the boarding schedule terminal received from the server 120, the weight of the vehicle changes, or the seat sensor detects the seating of the passenger.

The controller 115 may transmit the boarding information of the passenger to the server 120 when it is determined that the passenger having the boarding schedule terminal has boarded the vehicle. Meanwhile, when it is determined that the passenger carrying the boarding schedule terminal has not boarded, the controller 115 may transmit non-boarding information of the passenger to the server 120.

The controller 115 may update the remaining seat information when receiving information about a boarding completion terminal from the server 120. In addition, when the vehicle door is opened and then closed, the controller 115 may update the remaining seats. When the remaining seat information is updated, the controller 115 may transmit the updated information to the server 120.

When the controller 115 receives the alighting request information from the boarding completion terminal or determines that the passenger's alighting request is input through an input device (not shown, e.g., an alighting button) provided separately, the controller 115 may determine the boarding completion terminal as the alighting request terminal and determine the status of the passenger according to the location of the alighting request terminal. In this case, the alighting request information may include alighting request point (stop) information.

According to an embodiment, when the alighting request terminal moves to the first area within a specified distance from the door, the controller 115 may determine that the passenger carrying the alighting request terminal is in an alighting schedule state.

When the controller 115 determines that the passenger is in the alighting schedule state, the controller 115 may transmit arrival expectation information to the alighting request stop to the alighting request terminal. According to an embodiment, when it is predicted that it takes less than a specified time from the current location of the vehicle to the alighting request stop, the controller 115 may transmit the arrival expectation information to the alighting request terminal.

In addition, when it is determined that the alighting request terminal passes through the first area and moves to the outside of the vehicle after the vehicle arrives at the alighting request stop, the controller 115 may determine that the passenger carrying the alighting request terminal has completed alighting. Meanwhile, when it is determined that the alighting request terminal does not move to the outside of the vehicle after the vehicle arrives at the alighting request stop, the controller 115 may transmit a non-alight guidance message to the alighting request terminal.

The controller 115 may update the remaining seat information when determining that the passenger is in an alighting completion state. In addition, when the vehicle door is opened and then closed, the controller 115 may update the remaining seats. In addition, the controller 115 may transmit the updated remaining seat information to the server 120. In this case, the controller 115 may update the remaining seat information based on a passenger carrying an alighting request terminal who has not alighted at the alighting request stop and is scheduled to alight, and a passenger who has an alighting request terminal that has passed through the first area and moved to the outside of the vehicle and is in an alighting completion state. FIG. 3 is a block diagram illustrating the configuration of a server according to an embodiment of the present disclosure.

As shown in FIG. 3, the server 120 may include a communication device 121, storage 122, and a controller 123.

The communication device 121 may communicate with the vehicle 110 and the terminal 130 through various wireless communication schemes such as wireless-fidelity (Wi-Fi), wireless broadband (WiBro), global system for mobile communication (GSM), code division multiple access (CDMA), wideband CDMA (WCDMA), universal mobile telecommunications system (UMTS), time division multiple access (TDMA), long-term evolution (LTE), ultra-wideband (UWB), and the like.

The storage 122 may store at least one algorithm for performing calculation or execution of various commands for the operation of a server according to an embodiment of the present disclosure. The storage 122 may include at least one storage medium of a flash memory, a hard disk, a memory card, a read-only memory (ROM), a random-access memory (RAM), a programmable ROM (PROM), an electrically erasable PROM (EEPROM), a magnetic memory, a magnetic disk, and an optical disk.

The controller 123 may be implemented with various processing devices such as a microprocessor and the like in which a semiconductor chip capable of performing operations or executions of various commands is built-in and may control operations of a vehicle control apparatus according to an embodiment of the present disclosure. The controller 123 may be electrically connected to the communication device 121 and the storage 122 through a wired cable or various circuits to transmit an electrical signal including a control command and the like and may transmit/receive an electrical signal including a control command and the like through various wireless communication networks such as a controller area network (CAN).

When receiving the boarding request information from the terminal 130, the controller 123 may transmit the boarding request information to the vehicle 110. In addition, the controller 123 may determine the terminal from which the boarding request information is transmitted as the boarding schedule terminal. In this case, the boarding request information may include a boarding request stop, sharing vehicle information (e.g., a bus or a taxi), and the like.

The controller 123 may transmit the boarding schedule terminal information to the vehicle 110.

The controller 123 may receive the vehicle location information and the remaining seat information from the vehicle 110 and determine whether the vehicle 110 is approaching the boarding request stop. According to an embodiment, when it is determined that less than a specified time is required from the current location of the vehicle 110 to the boarding request stop, the controller 123 may determine that the vehicle 110 is approaching the boarding request stop.

When it is determined that the vehicle 110 is approaching the boarding request stop, the controller 123 may generate vehicle arrival expectation information and transmit the arrival expectation information and the remaining seat information to the boarding schedule terminal.

The controller 123 may determine whether there is an available seat for the passenger based on the remaining seat information received from the vehicle 110.

When it is determined that there is an available seat for the passenger, the controller 123 may request the location of the boarding schedule terminal to the boarding schedule terminal and receive the location of the boarding schedule terminal. Meanwhile, when it is determined that there is no available seat for the passenger, the controller 123 may transmit a message of guiding to use another vehicle to the boarding schedule terminal.

The controller 123 may determine whether the passenger is capable of boarding the vehicle based on the location of the boarding schedule terminal. According to an embodiment, the controller 123 may predict the arrival time of the vehicle to the boarding request stop based on the location of the vehicle and determine whether the passenger can board the vehicle based on whether the boarding schedule terminal can arrive at the boarding request stop within a critical time after the arrival time of the vehicle.

When the boarding schedule terminal can arrive at the boarding request stop within a critical time after the arrival time of the vehicle, the controller 123 may determine that the passenger can board the vehicle. When the boarding schedule terminal cannot arrive at the boarding request stop within a critical time after the arrival time of the vehicle, the controller 123 may determine that it is impossible for the passenger to board the vehicle.

When it is determined that it is impossible for the passenger to board the vehicle, the controller 123 may transmit a message of guiding to use another vehicle to the boarding schedule terminal.

When it is determined that it is possible for the passenger to board the vehicle, the controller 123 may receive vehicle arrival information from the vehicle 110 and transmit the received vehicle arrival information to the boarding schedule terminal.

The controller 123 may receive vehicle arrival information to the boarding request stop from the vehicle 110 and may transmit the vehicle arrival information to the terminal 130.

When the controller 123 receives the boarding information of the passenger from the vehicle 110, the controller 123 may determine the boarding schedule terminal of the passenger who has boarded the vehicle 110 as the boarding completion terminal and transmit information on the boarding completion terminal to the vehicle 110.

When the controller 123 receives the non-boarding information of the passenger from the vehicle 110, the controller 123 may transmit a non-boarding guidance message to the boarding schedule terminal possessed by the non-boarding passenger.

The controller 123 may receive the updated remaining seat information from the vehicle 110. When the updated remaining seat information is received, the controller 123 may transmit the updated remaining seat information from the vehicle 110 to the boarding schedule terminal to allow the passenger to check the remaining seat information in real-time.

FIG. 4 is a block diagram illustrating the configuration of a terminal according to an embodiment of the present disclosure.

As shown in FIG. 4, the terminal 130 may include a communication device 131, an output device 132, a location-obtaining device 133, storage 134, and a controller 135.

The communication device 131 may communicate with the vehicle 110 and the server 120 through various wireless communication schemes such as wireless-fidelity (Wi-Fi), wireless broadband (WiBro), global system for mobile communication (GSM), code division multiple access (CDMA), wideband CDMA (WCDMA), universal mobile telecommunications system (UMTS), time division multiple access (TDMA), long-term evolution (LTE), ultra-wideband (UWB), and the like.

The output device 132 may output information received from the vehicle 110 or the server 120. According to an embodiment, the output device 132 may be implemented as a display device, a sound output device, or the like. According to an embodiment of the present disclosure, the display device may be implemented integrally with the input device to receive boarding request information or alighting request information from a passenger.

The location-obtaining device 133 may be provided with a GPS receiving device to obtain location information of a terminal in real-time. The location-obtaining device 133 may provide, through the output device 132, a map image of a certain area based on the location of a terminal by map-matching the location of the vehicle to map data stored in advance.

The storage 134 may store at least one algorithm for performing calculation or execution of various commands for operation of a terminal according to an embodiment of the present disclosure. The storage 134 may include at least one storage medium of a flash memory, a hard disk, a memory card, a read-only memory (ROM), a random-access memory (RAM), a programmable ROM (PROM), an electrically erasable PROM (EEPROM), a magnetic memory, a magnetic disk, and an optical disk.

The controller 135 may be implemented with various processing devices such as a microprocessor and the like in which a semiconductor chip capable of performing operations or executions of various commands is built-in. The controller 135 may control operations of a vehicle control apparatus according to an embodiment of the present disclosure. The controller 135 may be electrically connected to the communication device 131, the output device 132, and the storage 134 through a wired cable or various circuits to transmit an electrical signal including a control command, and the like. The controller 135 may transmit/receive an electrical signal including a control command and the like through various wireless communication networks such as a controller area network (CAN).

When receiving boarding request information or alighting request information from a passenger, the controller 135 may transmit the input information to the server 120.

When receiving a request to transmit the terminal location from the server 120, the controller 135 may transmit the terminal location to the server 120.

The controller 135 may output information received from the server 120 or the vehicle 110 through the output device 132.

According to an embodiment, the controller 135 may output a message of guiding to use another vehicle through the output device 132 when receiving the message of guiding to use another vehicle from the server 120.

When receiving the vehicle arrival information from the server 120, the controller 135 may output the vehicle arrival information through the output device 132.

When receiving a non-boarding guidance message from the server 120, the controller 135 may output the non-boarding guidance message through the output device 132.

When receiving the updated information of the remaining seats from the server 120, the controller 135 may output the updated information of the remaining seats through the output device 132.

When receiving stop arrival expectation information from the vehicle 110, the controller 135 may output the stop arrival expectation information through the output device 132.

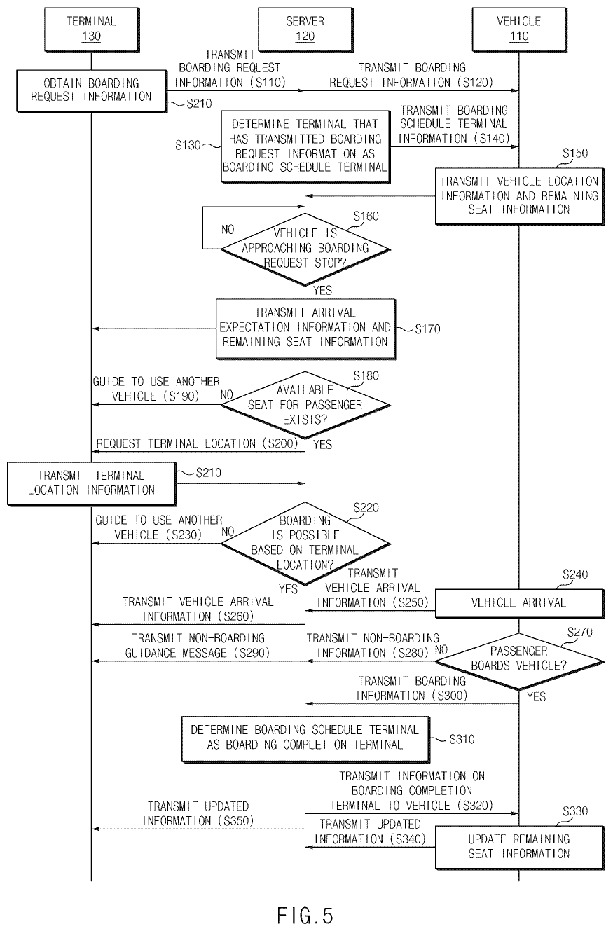

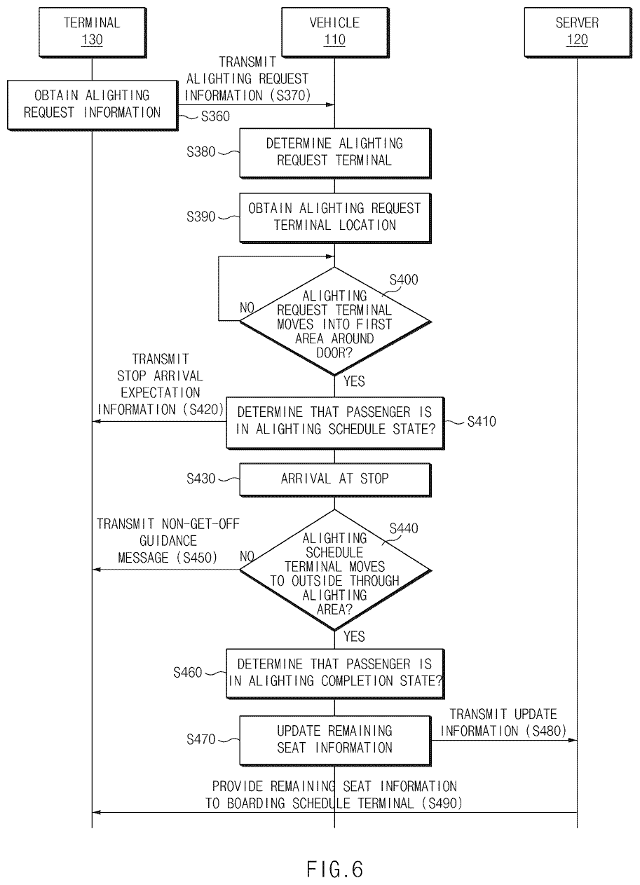

FIGS. 5 and 6 are diagrams illustrating a vehicle control method according to an embodiment of the present disclosure.

The terminal 130 may receive the boarding request information from the passenger to obtain the boarding request information in operation S100 and may transmit the boarding request information to the server 120 in operation S110l. In addition, the server 120 may transmit the boarding request information received from the terminal 130 to the vehicle 110 in operation S120.

The server 120 may determine the terminal that has transmitted the boarding request information as the boarding schedule terminal in operation S130l. The server 120 may transmit boarding schedule terminal information to the vehicle 110 in operation S140.

When the vehicle 110 receives the boarding schedule terminal information from the server 120, the vehicle 110 may transmit the vehicle location information and the remaining seat information to the server 120 in operation S150.

In operation S160, the server 120 may determine whether the vehicle is approaching the boarding request stop corresponding to the boarding request information.

When it is determined in operation S160 that the vehicle approaches the boarding request stop, in operation S170, the server 120 may generate the vehicle arrival expectation information and transmit the arrival expectation information and remaining seat information to the boarding schedule terminal.

In operation S180, the server 120 may determine whether there is an available seat for a passenger based on the remaining seat information. When it is determined that there is no available seat for a passenger, in operation S190, the server 120 may transmit a message of guiding to use another vehicle to the boarding schedule terminal.

Meanwhile, the server 120 may request the terminal location to the boarding schedule terminal when there is an available seat for a passenger in operation S200. The boarding schedule terminal may transmit the terminal location information to the server 120 in operation S210.

In operation S220, the server 120 may determine whether the passenger is capable of boarding the vehicle based on the location of the boarding schedule terminal. According to an embodiment, in operation S220, the server 120 may predict the arrival time of the vehicle to the boarding request stop based on the location of the vehicle. The server 120 may determine whether the passenger can board the vehicle based on whether the boarding schedule terminal can arrive at the boarding request stop within a critical time after the arrival time of the vehicle.

When the boarding terminal can arrive at the boarding request stop within a critical time after the arrival time of the vehicle, the server 120 may determine that the passenger can board the vehicle. When the boarding schedule terminal cannot arrive at the boarding request stop within a critical time after the arrival time of the vehicle, the server 120 may determine that it is impossible for the passenger to board the vehicle.

When it is determined in operation S220 that it is impossible for the passenger to board the vehicle, in operation S230, the server 120 may transmit the message of guiding to use another vehicle to the boarding schedule terminal.

When it is determined in operation S240 that the vehicle 110 has arrived at the boarding request stop, the vehicle 110 may transmit vehicle arrival information to the server 120 in operation S250. Although not shown, in operation S250, the vehicle 110 may request the location of the boarding schedule terminal and may receive the location of the boarding schedule terminal from the server 120.

When the server 120 receives the vehicle arrival information from the vehicle 110, the server 120 may transmit the vehicle arrival information to the boarding schedule terminal in operation S260.

In operation S270, the vehicle 110 may determine the boarding of the passenger after the vehicle arrives at the boarding request stop.

According to an embodiment, in operation S270, the vehicle 110 may determine that a passenger has boarded the vehicle when the boarding schedule terminal is in the vehicle based on the location of the boarding schedule terminal received from the server 120, the weight of the vehicle changes, or the seat sensor detects the seating of the passenger.

When it is determined that the passenger carrying the boarding schedule terminal has not boarded the vehicle 110, the vehicle 110 may transmit non-boarding information of the passenger to the server 120 in operation S280. In addition, in operation S290, the server 120 may transmit a non-boarding guidance message to the boarding schedule terminal

Meanwhile, the vehicle 110 may transmit the boarding information of the passenger to the server 120 when it is determined that the passenger having the boarding schedule terminal has boarded the vehicle 110.

When the server 120 receives the boarding information of the passenger, the server 120 may determine the boarding schedule terminal as the boarding completion terminal in operation S310. In addition, in operation S320, the server 120 may transmit information on the boarding completion terminal to the vehicle.

In operation S330, the vehicle 110 may update the remaining seat information when receiving information about a boarding completion terminal from the server 120. In operation S330, when the vehicle door is opened and then closed, the vehicle 110 may update the remaining seats. When the remaining seat information is updated, the vehicle 110 may transmit the updated information to the server 120 in operation S340.

In operation S350, the server 120 may transmit the updated information received from the vehicle 110 to the boarding schedule terminal.

As shown in FIG. 6, the terminal (boarding completion terminal) may obtain the alighting request information input from the passenger in operation S360. The boarding completion terminal may transmit the alighting request information to the vehicle 110 in operation S370.

When the vehicle 110 receives the alighting request information from the boarding completion terminal or determines that the passenger's alighting request is input through an input device (not shown, e.g., an alighting button) provided separately, the vehicle 110 may determine the boarding completion terminal as the alighting request terminal in operation S380.

The vehicle 110 may obtain the location of the alighting request terminal in operation S390 and determine whether the alighting request terminal moves into the first area within a specified distance from the door in operation S400. When it is determined in operation S400 that the alighting request terminal moves into the first area within the specified distance from the door, in operation S410, the vehicle may determine that the passenger having the alighting request terminal is in an alighting schedule state.

When it is determined that the passenger is in the alighting schedule state, the vehicle 110 may transmit arrival expectation information to an alighting request stop to the alighting request terminal in operation S420.

According to an embodiment, when it is predicted that it takes less than a specified time from the current location of the vehicle to the alighting request stop, in operation S420, the vehicle 110 may transmit the arrival expectation information to the alighting request terminal.

The vehicle 110 may determine that the vehicle 110 has arrived at the alighting request stop in operation S430. The vehicle 110 may determine whether the alighting request terminal passes through the first area and moves to the outside of the vehicle after the vehicle arrives at the alighting request stop in operation S440.

When it is determined in operation S440 that the alighting request terminal does not move to the outside of the vehicle after the vehicle arrives at the alighting request stop, in operation S450, the vehicle 110 may transmit a non-alight guidance message to the alighting request terminal.

When it is determined in operation S440 that the alighting request terminal moves to the outside of the vehicle after the vehicle arrives at the alighting request stop, in operation S460, the vehicle 110 may determine that the passenger carrying the alighting request terminal is in an alighting completion state.

When it is determined that the passenger is in the alighting completion state, the vehicle 110 may update the remaining seat information in operation S470. In operation S470, the vehicle 110 may update the remaining seat information based on a passenger carrying an alighting request terminal who has not alighted at the alighting request stop and is scheduled to alight, and a passenger who has an alighting request terminal that has passed through the first area and moved to the outside of the vehicle and is in an alighting completion state. In addition, when the vehicle door is opened and then closed, in operation S470, the vehicle 110 may update the remaining seats. In addition, the vehicle 110 may transmit the updated remaining seat information to the server 120 in operation S480. The server 120 may transmit the updated remaining seat information to the boarding schedule terminal in operation S490.

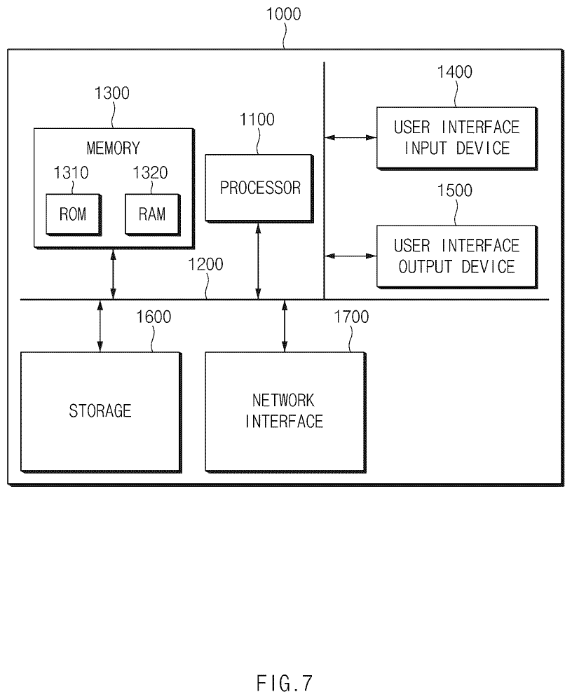

FIG. 7 is a block diagram illustrating a computing system according to an embodiment of the present disclosure.

Referring to FIG. 7, a computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) 1310 and a Random Access Memory (RAM) 1320.

Accordingly, the processes of the method or algorithm described in relation to embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid-state drive (SSD), a detachable disk, or a compact-disk ROM (CD-ROM). The storage medium is coupled to the processor 1100, and the processor 1100 may read information from the storage medium and may write information in the storage medium. In another method, the storage medium may be integrated with the processor 1100. The processor and the storage medium may reside in an application-specific integrated circuit (ASIC). The ASIC may reside in a user terminal. In another method, the processor and the storage medium may reside in the user terminal as individual components.

According to embodiments of the present disclosure, the vehicle control system and method may manage the boarding and alighting of passengers in a shared autonomous vehicle to expand a vehicle-sharing service to passengers, thereby providing convenience to passengers.

Although embodiments of the present disclosure have been described for illustrative purposes, those having ordinary skill in the art should appreciate that various modifications, additions, and substitutions are possible, without departing from the scope and spirit of the disclosure.

Therefore, the embodiments disclosed in the present disclosure are provided for the sake of descriptions, not limiting the technical concepts of the present disclosure. It should be understood that such embodiments are not intended to limit the scope of the technical concepts of the present disclosure. The protection scope of the present disclosure should be understood by the claims below. All the technical concepts within the equivalent scopes should be interpreted to be within the scope of the right of the present disclosure.

What is claimed is:

1. A vehicle control system comprising:
a terminal configured to obtain boarding request information from a passenger;
a vehicle configured to update vehicle location information and remaining seat information; and
a server configured to
determine the terminal as a boarding schedule terminal when receiving the boarding request information from the terminal, and
determine whether the passenger can board a vehicle based on a location of the boarding schedule terminal when it is determined that the vehicle approaches a stop corresponding to the boarding request information.

2. The vehicle control system of claim 1, wherein the server is configured to receive the vehicle location information and the remaining seat information from the vehicle when the terminal is determined as the boarding schedule terminal.

3. The vehicle control system of claim 2, wherein the server is configured to
determine an expected arrival time of the vehicle based on the vehicle location information, and
transmit the expected arrival time of the vehicle and the remaining seat information to the boarding schedule terminal when it is determined that the vehicle approaches the stop corresponding to the boarding request information.

4. The vehicle control system of claim 2, wherein the server is configured to determine whether there is an available seat for the passenger based on the remaining seat information.

5. The vehicle control system of claim 4, wherein the server is configured to receive a location of the boarding schedule terminal from the boarding schedule terminal when it is determined that there is an available seat for the passenger.

6. The vehicle control system of claim 1, wherein the server is configured to transmit a message of guiding another vehicle to the boarding schedule terminal when it is determined that there is no available seat for the passenger.

7. The vehicle control system of claim 1, wherein the server is configured to
receive arrival information from the vehicle, and
transmit the arrival information to the boarding schedule terminal when it is determined that the passenger can board the vehicle.

8. The vehicle control system of claim 1, wherein the server is configured to
receive boarding information of the passenger from the vehicle,
determine the boarding schedule terminal of the passenger that boards the vehicle as a boarding completion terminal, and
transmit information on the boarding completion terminal to the vehicle when it is determined that the passenger boards the vehicle.

9. The vehicle control system of claim 8, wherein the server is configured to
receive non-boarding information of the passenger from the vehicle, and
transmit a non-boarding guide message to the boarding schedule terminal of the passenger that does not board the vehicle when it is not determined that the passenger boards the vehicle.

10. The vehicle control system of claim 9, wherein the boarding completion terminal is configured to obtain alighting request information.

11. The vehicle control system of claim 10, wherein the vehicle is configured to
determine the boarding completion terminal as an alighting request terminal, and
determine a state of the passenger according to a location of the alighting request terminal when it is determined that the alighting request information is received from the boarding completion terminal or the passenger inputs the alighting request information.

12. The vehicle control system of claim 11, wherein the vehicle is configured to determine that the passenger is in an alighting schedule state when the alighting request terminal moves into a first area within a specified distance from a door.

13. The vehicle control system of claim 12, wherein the vehicle is configured to transmit arrival expectation information to an alighting request stop corresponding to the alighting request information to the alighting request terminal when it is determined that the passenger is in the alighting schedule state.

14. The vehicle control system of claim 13, wherein the vehicle is configured to determine that the passenger is in an alighting completion state when the alighting request terminal passes through the first area and moves to an outside of the vehicle after arrival at the alighting request stop.

15. The vehicle control system of claim 14, wherein the vehicle is configured to transmit a non-alight guidance message to the alighting request terminal when it is determined that the alighting request terminal does not move to an outside of the vehicle after the arrival of the alighting request stop.

16. The vehicle control system of claim 14, wherein the vehicle is configured to update the remaining seat information based on the passenger that is in the alighting schedule state and the passenger that is in the alighting completion state when it is determined that the passenger is in the alighting completion state.

17. The vehicle control system of claim 16, wherein the vehicle is configured to transmit the updated remaining seat information to the server.

18. A vehicle control method comprising:
obtaining boarding request information from a passenger;
determining a terminal as a boarding schedule terminal when receiving the boarding request information from the terminal; and
determining whether the passenger can board a vehicle based on a location of the boarding schedule terminal when it is determined that the vehicle approaches a stop corresponding to the boarding request information.

19. The vehicle control method of claim 18, further comprising:
determining the boarding schedule terminal of the passenger that boards the vehicle as a boarding completion terminal when it is determined that the passenger boards the vehicle.

20. The vehicle control method of claim 19, further comprising:
determining the boarding completion terminal as an alighting request terminal; and
determining a state of the passenger according to a location of the alighting request terminal when it is determined that alighting request information is received from the boarding completion terminal or the passenger inputs the alighting request information.
